(19) United States
(12) Patent Application Publication
(10) Pub. No.: US 2021/0083566 A1
(43) Pub. Date: Mar. 18, 2021

(54) SELF-SCALABLE PHASE-MODULE ARCHITECTURE WITH ADAPTIVE CURRENT SHARING

(71) Applicant: DONGGUAN CHANGGONG MICROELECTRONICS LTD, DONGGUAN (CN)

(72) Inventors: XUENING LI, DONGGUAN (CN); JIAN CHEN, DONGGUAN (CN)

(73) Assignee: DONGGUAN CHANGGONG MICROELECTRONICS LTD, DONGGUAN (CN)

(21) Appl. No.: 16/571,070

(22) Filed: Sep. 14, 2019

(51) Int. Cl. H02M 1/084; H02M 3/158

(52) U.S. Cl. CPC H02M 1/084; H02M 2003/1586; H02M 3/1584

(57) ABSTRACT

The present invention comprises a phase-module for phase add and drop in self-scalable fashion to achieve adaptive current sharing method, wherein includes a unique power device with features and functions such as a phase current threshold circuit, a current sharing bus circuit, a phase voltage detection circuit and a phase location programming capability. The phase-module is designed to be automatically added by a designed higher threshold current and is designed to be automatically dropped by a designed lower threshold current.

### TECHNICAL FIELD

The present disclosure relates to a power semiconductor device and applied power electronics circuits, and more particularly, on how to add and drop phase for the stackable voltage regulator with a unique power semiconductor device.

### BACKGROUND

According to the Moore's law, the transistor density will double every eighteen months. The corresponding increase in transistor density will require higher power demand, and to meet the increased power demand, the power supply unit, which supplies power to the device, will need to increase its power rating accordingly whether, for example, the device is a processor, memory module, or switch router. To increase the power rating of the power supply unit, the power supply unit needs to be redesigned to meet the new power requirements, which take resources, risk, and time.

FIG. 1 shows an 8-phase power converter. The multi-phase power converter can provide higher power with designed multi-phase controller 100 and phase modules numbered from 101 to 108. The multi-phase controller 100 provides the pulse-width-modulation (PWM) signal to enable each phase-module 101-108. The multi-phase controller 100 receives the current monitor signal (IMON) from phase-module 101-108 to manage each phase-module current. Each phase module 101-108 delivers the power from its respective VIN to OUT node. However, the general multi-phase power converter solution requires a multi-phase controller and many connections from the PWM controller to each of the phase-modules, which increase the overall circuit complexity and result in the PCB layout difficulty.

### SUMMARY

Embodiments of the present invention are directed to a method of phase add and drop for a voltage-regulator (VR) through self-scalable phase-modules. The phase-module is in a unique definition and has self-scalable feature to add and drop a phase with adaptive current sharing method. Therefore, a voltage regulator using self-scalable phase-modules possesses self-scalable and current sharing advantages. Unlike a conventional VR architecture and prior art, self-scalable phase-module based VR does not need a centralized controller to coordinate all of phases working together. A phase-module includes a unique power device, capacitor, and inductor, the phase-module of which is coupled between an input voltage and an output node. The unique power device has basic features and function such as voltage-detection, current-monitoring and reporting, voltage-regulation and phase location programming. The phase voltage detection circuit is connected to an external resistor between the phase voltage detection node and another phase-module. A current reporting bus circuit is also coupled with another phase-module and an external resistor to ground in addition to a phase current setting circuit, which is coupled between an external resistor and ground. The designed phase-module will be added and dropped by means of preset phase current threshold.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of a general 8-phase power converter with eight phase modules in accordance with the prior art;

FIG. 2 illustrates a block diagram of an 8-phase power converter in accordance with certain embodiments of the present disclosure;

FIG. 3 illustrates the curve of the normalized phase voltage versus the normalized current threshold, in accordance with certain embodiments of the present disclosure;

FIG. 4 illustrates the curve of the operation phase modular quantity versus total output current, in accordance with certain embodiments of the present disclosure;

FIG. 5 illustrates the curve of the operation phase modular quantity versus phase output current, in accordance with certain embodiments of the present disclosure;

FIG. 6 is a flowchart that illustrates phase module control algorithm, in accordance with certain embodiments of the present disclosure.

### DETAILED DESCRIPTION

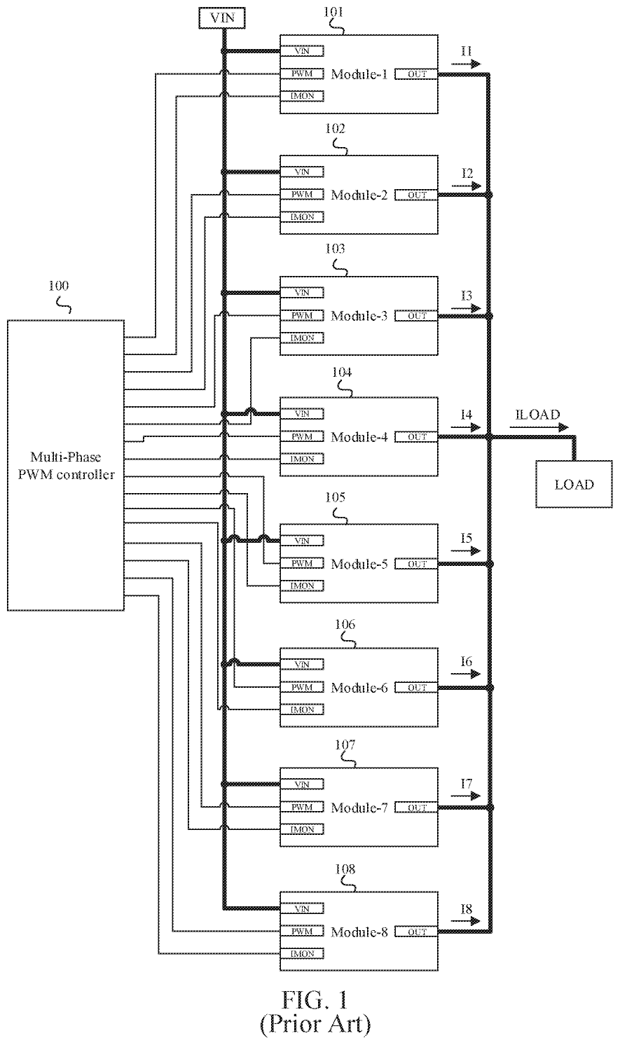

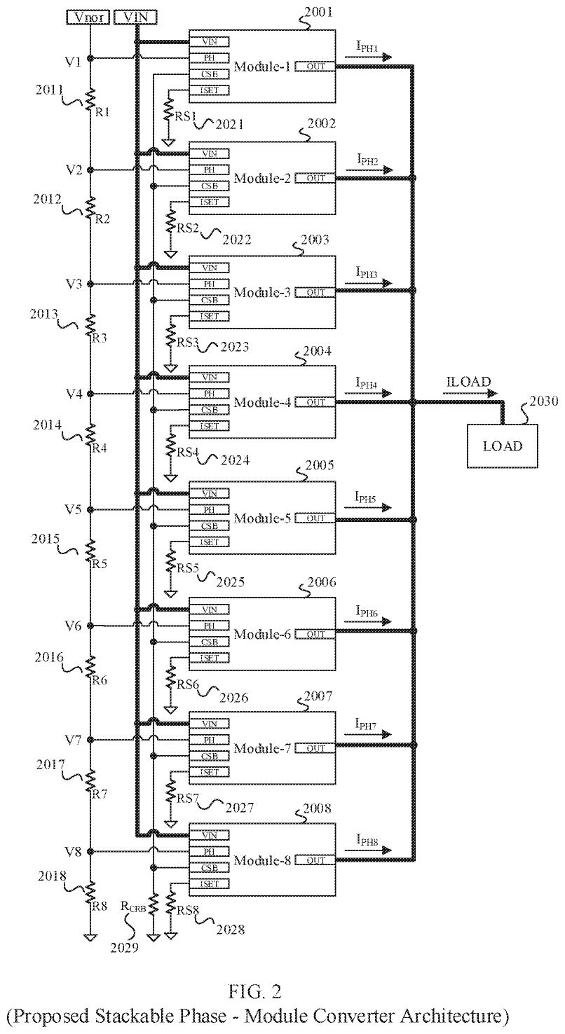

Differentiating from prior arts, which need a centralized controller as shown in FIG. 1, FIG. 2 illustrates eight stackable phase-modules for an 8-phase voltage-regulator application in accordance with a non-limiting embodiment of the present technology. As shown in FIG. 2, each input and output of phase-module 2001-2008 are connected to deliver the power from VIN to OUT node for supplying the energy for LOAD 2030. The output current of phase-module 2001-2008 are represented as I_{PH1}-I_{PH8}. Based on the Kirchhoff s current law, the output loading current ILOAD is the summation of the individual currents as follows:

ILOAD=I_{PH1}+I_{PH2}+ . . . +I_{PH8} (1)
Each phase module 2001-2008 may or may not connect to the same VIN. Eight phase resistors R1-R8 2011-2018 are connected in series across a normalized voltage Vnor. Each voltage of phase resistors R1-R8 2011-2018 are the phase voltage V1-V8. The eight phase-modules 2001-2008 detect the phase voltage V1-V8 via each PH node. The PH node is the input of phase voltage detection circuit of phase-module. The phase voltage V_{PH}: V1-V8 can be represented as:

$${V}_{PH\_m} = \frac{Vnor}{{\sum }_{k = 1}^{k = 8} {R}_{k}} \times {\sum }_{k = 1}^{m} {R}_{k} \qquad ( 2 )$$

where the V_{PH_m} is one of the phase voltages V1-V8, Rₖ is one such phase resistor, and k and m are the constants from 1 to 8, respectively.

Second, a current reporting bus resistor R_{CRB} 2029 collects all output current information of each phase-module 2001-2008 to present the overall output current.

V_{CRB}=K×ILOAD (3)

where the V_{CRB} is the voltage across the R_{CRB}, and K is a transconductor constant. The bus voltage is the input of the current reporting circuit of phase-module.

Third, the setting resistors RS1-RS8 2021-2028 are connected to the ISET node of each phase-module 2001-2008. The setting resistors RS1-RS8 2021-2028 determine the phase modules 2001-2008 add and drop.

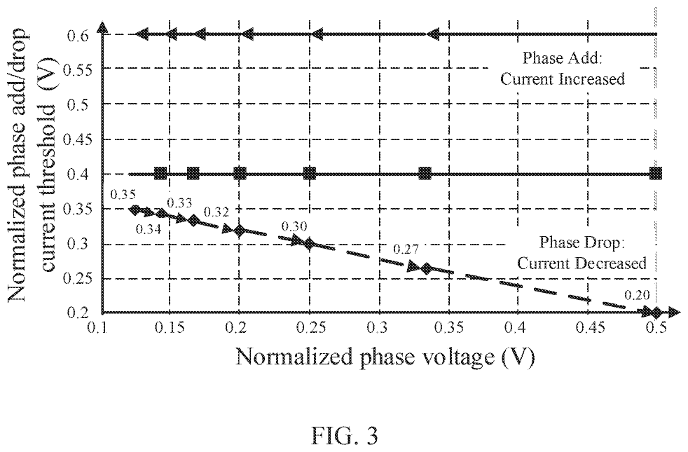

FIG. 3 illustrates a normalized phase voltage and normalized current threshold of phase modules 2001-2008 in accordance with such a non-limiting embodiment of the present technology. By changing the resistance of R1-R8 2011-2018 as shown in FIG. 2, the phase-module add and drop thresholds will be changed accordingly. A non-limiting embodiment is designed as Vₙₒᵣ is 1V, and IMAX=1 A. The current drop threshold of this embodiment is shown as:

I_{drp_m}=0.4*IMAX*(Vₙₒᵣ−V_{PH,m})/Vₙₒᵣ (4)

where the I_{drp_m} is the drop current threshold, and m is a constant from 2 to 8. For this embodiment, once the current of phase-module is higher than I_{add}, e.g. 60% of IMAX in this scenario, the designed phase-module will be added. When the output current of phase-module is lower than I_{drp_m} as (4) shows, the phase-module will be dropped. Each drop current threshold is different among the eight phase-modules 2001-2008.

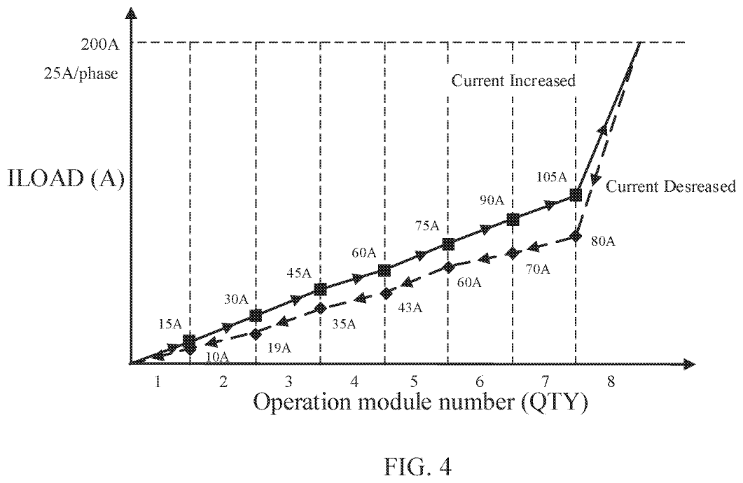

FIG. 4 illustrates the load current versus the quantity of operation phase module 2001-2008 in accordance with a non-limiting embodiment of the present technology. In the embodiment, the total output current is designed to support 200 A in maximum. Each phase-module is designed to support 25 A in maximum. The second to eighth phase-modules are designed to add once the current reaches 60% of 25 A of the phase module current as the solid line with squares shows. On the other hand, the second to eighth phase-module are designed to drop once the current is lower than 20% to 40% of 25 A of the phase module current as the dotted line with diamonds shows.

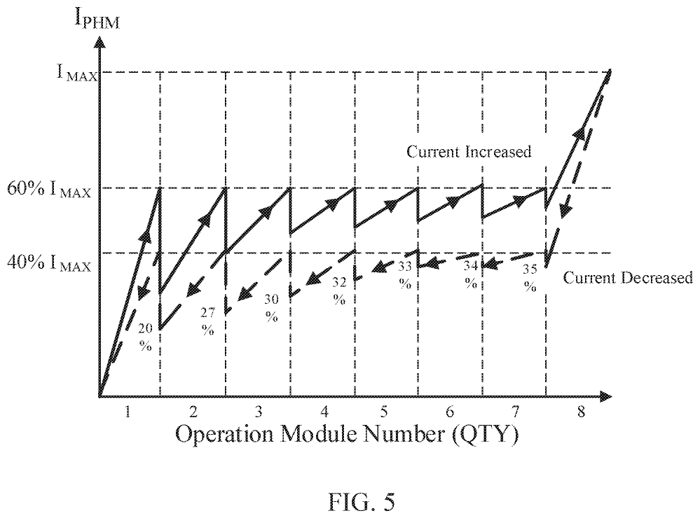

FIG. 5 illustrates output current of each phase-module and the quantity of operation phase-module 2001-2008 in accordance with a non-limiting embodiment of the present technology. The second to eighth phase-modules are designed to add once the current reaches 60% of 25 A as the solid line shows. On the other hand, the second to eighth phase-module are designed to drop once the current is lower than 20% to 40% of 25 A as the dotted line shows.

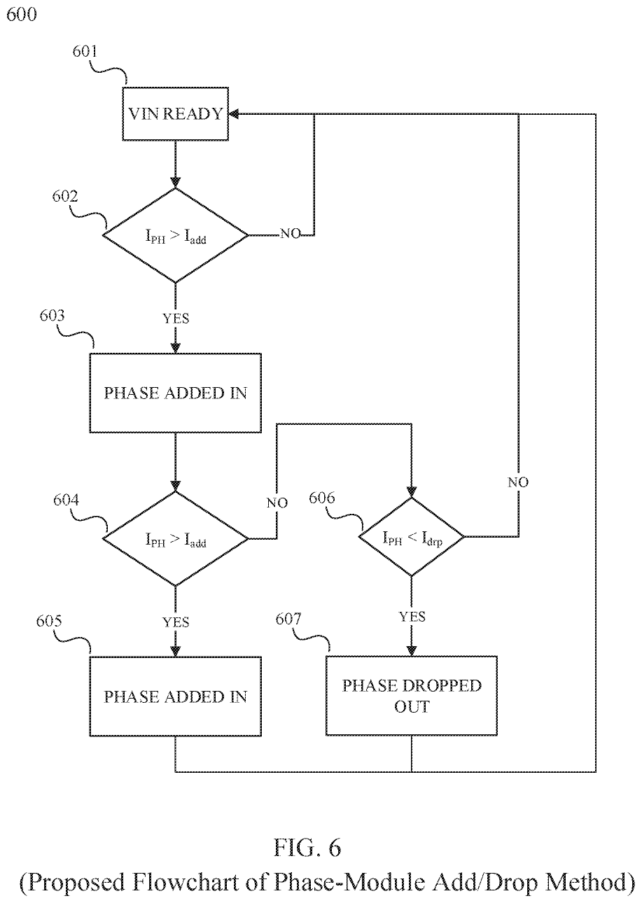

FIG. 6 is the flowchart illustrating an example method 600 for the phase-module added or dropped. The method 600 is described with reference to FIGS. 2 to 5. For purposes of context for the particular embodiment described above, the below references to I_{add} can be taken as 60% of IMAX.
At block 601, VIN is ready for phase-module operation.
At block 602, check if the phase current I_{PH} is larger than I_{add} or not. If I_{PH} is higher than I_{add}, go to block 603. If not, go to block 601 and wait for I_{PH} to get higher than I_{add}.
At block 603, designed phase-module is added.
At block 604, check if the phase current I_{PH} is larger than I_{add} or not. If I_{PH} is higher than I_{add}, go to block 605. If not, go to block 606 and check if the phase current I_{PH} is lower than I_{drp} preset threshold or not.
At block 605, designed phase-module is added and go to block 601.
At block 606, check if the phase current I_{PH} lower than the I_{drp} preset threshold or not. If I_{PH} is lower than the I_{drp} preset threshold, go to block 607. If not, go to block 601 and wait for I_{PH} change.
At block 607, designed phase-module is dropped and go to block 601.

The exemplary, non-limiting embodiments were chosen and described in order to better explain the principles of the invention and the most possible practical application, and to help peers with ordinary skill in the art to understand the disclosure for various embodiments with possible modifications. Various changes in an actual implementation may be made although the above exemplary embodiments have been used for illustration. In addition, many modifications can be made to adapt to a specific application or a particular system, to the teachings of the disclosure without departing from the essential scope thereof. Therefore, the disclosure is not to be limited to the exemplary embodiments disclosed for implementing this disclosure. Moreover, all derived or evolved embodiments be covered within the scope of the appended claims. In addition, the references, definitions, and terminologies used herein are to describe specific embodiments only and are not intended to be limiting of the disclosure.

1. (canceled)

2. (canceled)

3. (canceled)

4. (canceled)

5. A self-scalable phase-module, comprising:
a power conversion module;
a phase voltage detection circuit coupled with a resistor to another phase-module, wherein the phase voltage detection circuit is coupled with an external resistor to another phase-module for the phase-voltage detection circuit to detect an external voltage to determine the phase-module add and drop;
a current reporting bus circuit coupled with a resistor to ground;
a phase current threshold setting circuit coupled with a resistor to ground.

6. The phase voltage detection circuit of claim 5, wherein the phase voltage detection circuit further may or may not be replaced by the Inter-Integrated Circuit (I2C).

7. (canceled)

8. (canceled)

9. (canceled)
